(19) United States
(12) Patent Application Publication
(10) Pub. No.: US 2010/0076897 A1
(43) Pub. Date: Mar. 25, 2010

(54) MEDIA INVESTMENT AND INVENTORY MANAGEMENT SYSTEM AND METHOD

(75) Inventors: Harish Malani, Maharashtra (IN); Sanjay Behl, Maharashtra (IN); Pratap D. Singh, Maharashtra (IN); Vamsi Manne, Maharashtra (IN); Rameswar Misra, Maharashtra (IN); Karunesh Kumar, Maharashtra (IN); Upali Dasgupta, Maharashtra (IN)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Reliance Communications Limited

(21) Appl. No.: 12/563,415

(22) Filed: Sep. 21, 2009

(30) Foreign Application Priority Data
Sep. 19, 2008 (IN) 1892/MUM/2008

(51) Int. Cl. G06Q 30/00; G06Q 10/00

(52) U.S. Cl. 705/80; 705/14.4; 705/14.48

(57) ABSTRACT

A system and method that provides efficient management and analysis of campaigning is described. In one embodiment the method involves receiving inputs from user and maintaining performance of a campaign in a database to be used for further analysis and comparison with actual performance parameters of a campaign for later evaluation and deal making.

### FIELD OF THE INVENTION

The present invention generally relates to enterprise resource planning and more particularly to marketing analysis systems.

### BACKGROUND OF THE INVENTION

The concept of campaigning may be considered to be as old as the civilized habitation. Generally a campaign is important in communicating to the concerned audience the features of the product or service.

For a long time the campaigning systems worked on the concept of personal contact. With improvement in technology and communication systems the campaigning got over the bounds of place and community. Various mediums such as publishing, radio, television and Internet have emerged in modern campaigning world.

However, amalgamation of information overflow and various and varied campaigning means is very a complex and tedious task and therefore it becomes difficult for a campaigner to analyze and accordingly plan his/her next or current campaign.

There is therefore a need of a system of campaigning for management and analysis of such information and utilizing such system for efficient campaigning method.

### SUMMARY OF THE INVENTION

It is an object of the present invention to provide a novel system and method for media investment and inventory management.

In one embodiment herein, a plurality of modules is provided that maintain master data and transaction data for initializing a deal of transaction with a required media campaign; reviewing the deal; presenting the reviewed deal for approval; signing the deal on receipt of approval, else, renegotiating the deal and repeating the step of initializing the deal; outputting the signed deal to the media; and terminating the deal.

The master data is entered once and used for several times during the deal of transactions so that user time is saved and data security and accuracy are maintained. The plurality of modules may include but are not limited to a master data module, a channel master module, a language module, a campaign master information module, a radio station master module, an edition master module, a city and market mapping master.

In various embodiments of the present invention, the media includes television channels, radio channels and publication houses. In order to initialize the deal inputs may be accepted by the system. Accuracy of each data is validated before accepting the next data. The inputs include but are not limited to channel name, program name, and FCT rate from a master data module. Inputs of budget amount for media campaign from a user may also be accepted. Thereafter the total budget amount, utilized amount and available amount for further utilization in the process of media campaign may be calculated and recorded to accomplish the process of deal initialization.

Each deal of transaction may be reviewed by checking if the user is an authorized user; checking the date of release of the reviewed deal; and checking if the deal contract value is exceeding the total budget valued. if the deal contract value is exceeds the total budget valued, an alert message is outputted to the user.

A wrong selection of input by the user may stop the deal of transaction with an error message and the deal is restarted only if all the required data are reentered by the user.

Each deal of transaction may be allotted a unique deal number. Any unauthorized user is not allowed to edit the master data as per the embodiments of the present invention.

Other objects, features and advantages of the invention will be apparent from the drawings, and from the detailed description that follows below.

### BRIEF DESCRIPTION OF THE DRAWINGS

Reference will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments.

FIG. 1 shows a schematic diagram of the system for campaign management as per one embodiment of the present invention.

FIG. 2 illustrates a general deal making process followed as per one embodiment of the present invention.

FIG. 3 illustrates the deal making process followed for a television (TV) campaign as per one embodiment of the present invention.

FIG. 4 illustrates the deal making process followed for a publishing media Print campaign as per one embodiment of the present invention.

FIG. 5 illustrates the deal making process followed for a Radio campaign as per one embodiment of the present invention.

FIG. 6 illustrates the step of planning the campaign as per one embodiment of the present invention.

FIG. 7 illustrates the step of recording actual parameters of performance for evaluation as per one embodiment of the present invention.

FIG. 8 illustrates one of the validation procedures as per one embodiment of the present invention.

FIG. 9 illustrates one of the validation procedures as per one embodiment of the present invention.

FIG. 10 illustrates one of the validation procedures as per one embodiment of the present invention.

FIG. 11 illustrates one of the validation procedures in publishing medium as per one embodiment of the present invention

FIG. 12 illustrates one of the validation procedures in radio medium as per one embodiment of the present invention.

FIG. 13 illustrates one of the checking procedures as per one embodiment of the present invention.

### DETAILED DESCRIPTION OF THE INVENTION

A system and method for system and method for media investment and inventory management are described. In one embodiment of the present invention various modules are made available for execution of various steps involved in the media campaign.

The embodiments of the present invention may be utilized to configure hardware in order to produce results as per teachings of this invention.

In the following description, for purpose of explanation, specific details are set forth in order to provide an understanding of the invention. It will be apparent, however, to one skilled in the art that the invention may be practiced without these details. One skilled in the art will recognize that embodiments of the present invention, some of which are described below, may be incorporated into a number of enterprise resource planning systems. Structures and devices shown in the figures are illustrative of exemplary embodiments of the invention and are meant to avoid obscuring the invention. Furthermore, connections between components and/or modules within the figures are not intended to be limited to direct connections. Rather, data between these components and modules may be modified, re-formatted or otherwise changed by intermediary components and modules.

References in the specification to “one embodiment” or “an embodiment” means that a particular feature, structure, characteristic, or function described in connection with the embodiment is included in at lest one embodiment of the invention. The appearances of the phrase “in one embodiment” in various places in the specification are not necessarily all referring to the same embodiment.

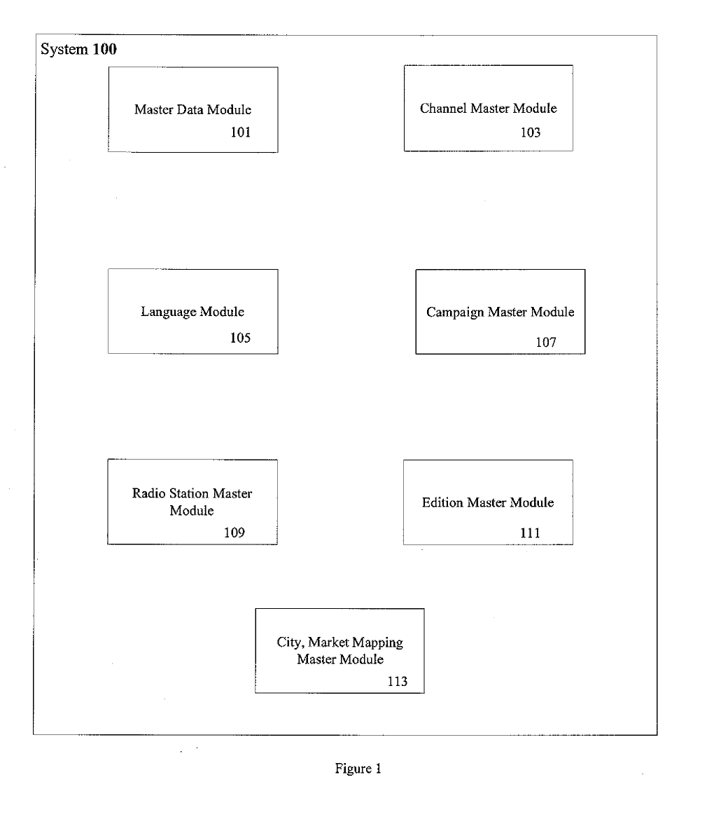

A system providing efficient management and analysis of campaigning is described as per an embodiment of the present invention shown in FIG. 1.

The system 100 may comprise various modules such as master data module, channel master module, language module, campaign master information module, radio station master module, edition master module, city and market mapping master module.

For the system to work the basic requirements include master data and transaction data. The master data is generally constant in nature, usually entered once and used for several times in the transactions so that user time will be saved and data security and accuracy may be maintained.

Various modules are configured in a database to contain respective information for example a channel master module maintains channel name, promoter name, channel inception date, channel revenue, channel popularity etc.

Detailed purpose and functioning of each module is provided herein below:

Channel Master 103 contains master data to be entered by the user once and accessed by the user for multiple times during transaction execution. The master details are channel name, network group, Date of Inception, Promoter name & address, Distribution alliance, License, Language.

Language master 105 Contains master info data to be entered by the user once and accessed by the user for multiple times during transaction execution. The master details can be for example En: English, Hi: Hindi etcetera.

Campaign master 107 contains master info data to be entered by the user once and accessed by the user for multiple times during transaction execution. The master details for the campaign master includes: Campaign name, Company name, Business Group, Campaign validity, and Budget amount for campaigns.

Radio Station master 109 contains master info data to be entered by the user once and accessed by the user for multiple times during transaction execution. The master details are Radio Station name, Date of inception, Promoter name, Language, Station Revenue.

Edition master 111 contains master info data to be entered by the user once and accessed by the user for multiple times during transaction execution. The master details are Publication name, Edition Type, Edition Name, Date of inception, Promoter name.

City/market mapping master 113 contain master info data to be entered by the user once and accessed by the user for multiple times during transaction execution. The master details are Name of city/market and Edition Name.

The master modules have the following features.
Aforesaid information (the master details) will be maintained in the system once and be used in various transactions for multiple times.
Editing by authorized users only.
Master data will be populated to transactions whenever there is a need that is user based call.
System validates the master data before accepting to it. For example, Numeric data will accept only numeric data not character data.
Master data info also restricted to number of characters like if the size of the field is 20 system will accept only 20 or less than 20 characters, in case user attempts to give more than that system throws error.

The system as configured checks the data accuracy and stores the data in the respective database or database table wherefrom the data may be recalled whenever required during transaction execution.

Further system is configured to validate the entries made for example system validates the data before accepting it into application. For instance, if a user attempts to enter character in a numeric field, the system 100 would not accept it and through errors messages identify such erroneous data feed. For example, channel revenue field cannot accept channel name, as it demands numeric field. Further data entered in the master data module once entered will be stored permanently unless and until edited. As an implication of the above the system is configured to not allow the user to edit it unless the user is authorized to do so.

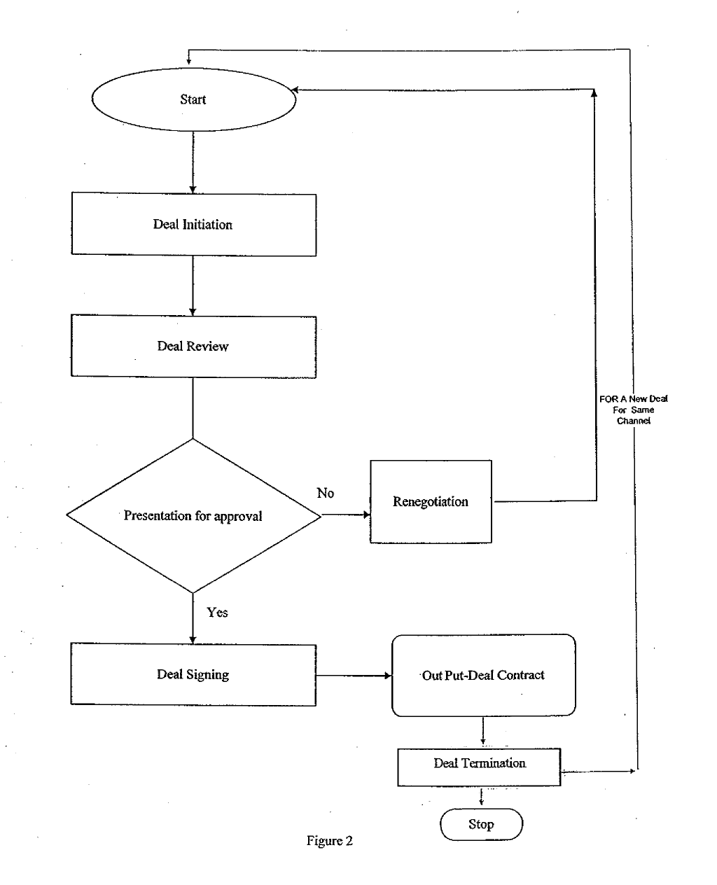

FIG. 2 illustrates a general deal making process followed as per an embodiment of the present invention. The method broadly comprises of the steps of initializing a deal of transaction with a required media campaign; reviewing the deal; presenting the reviewed deal for approval; signing the deal on receipt of approval, else, renegotiating the deal and repeating the step of initializing the deal; outputting the signed deal to the media; and terminating the deal.

The deal initialization comprises budgeting for media campaign, making a deal with television channels, radio channels/stations and publication houses, planning of campaigns in various media, recording actual parameters of performance for evaluation, reporting based on the evaluation.

The broad steps mentioned above are implemented in the system by using technical means for execution of each step.

When a deal is terminated, the existing deal contract with TV channel/Radio Station/News Agency or Print media comes to an end or becomes ineffective or null and void.

Further, all subsequent processes including plan entry, plan scheduler, actual entry are not possible after termination of deal contract. This is because the planning and actual entries are executed on the basis of a valid deal contract which must be effective and a binding factor between the advertiser and the media agency.

Furthermore, after termination of an existing deal contract with TV Channel, Radio Station, Print Media, a new deal contract can be entered with the same TV Channel, radio station, Print Media for the same period. This is because there must have been always a single live deal for the same period with the same channel, radio station or print agency.

The further steps involved within each of the broad steps mentioned above are explained below.

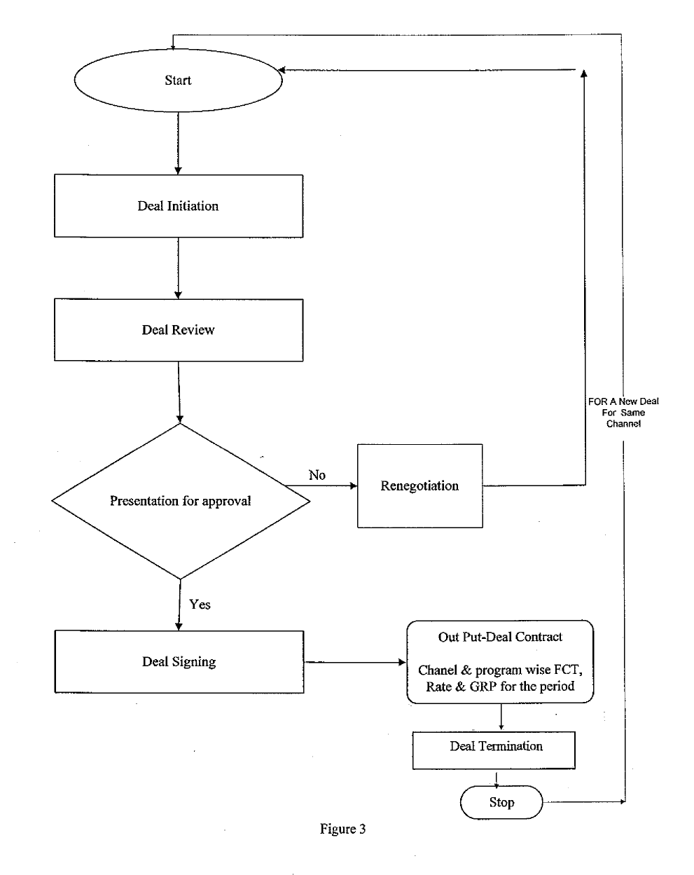

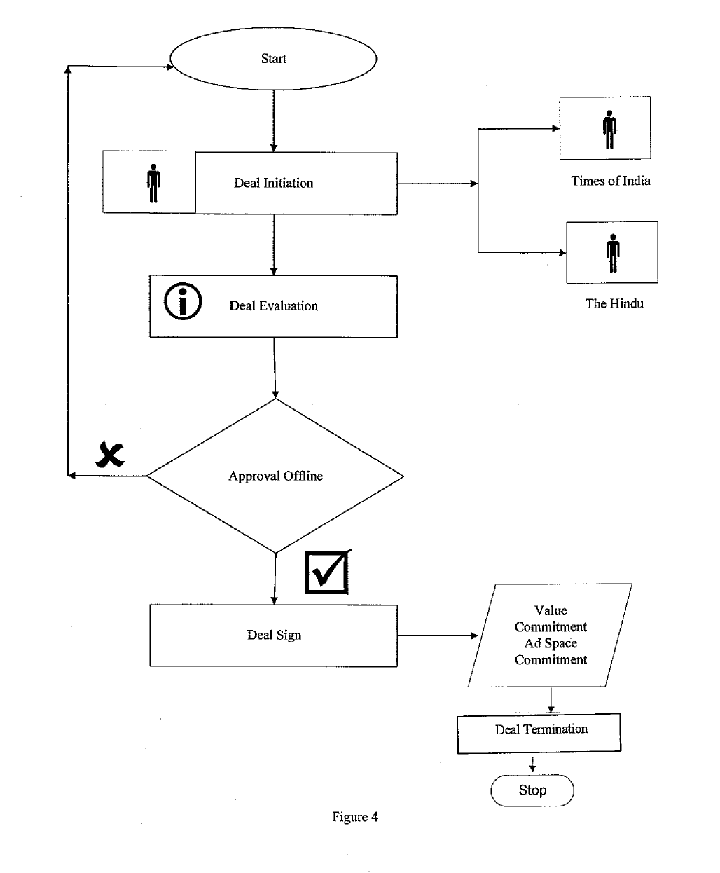

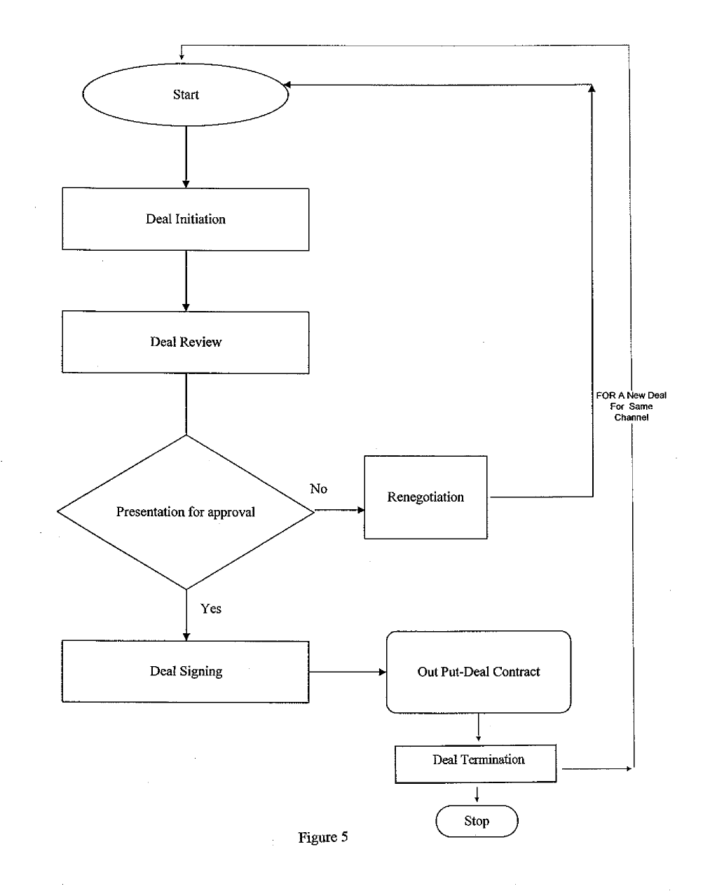

Also FIGS. 3, 4 and 5 are specific implementation for mediums such as TV, publications and radio mediums respectively.

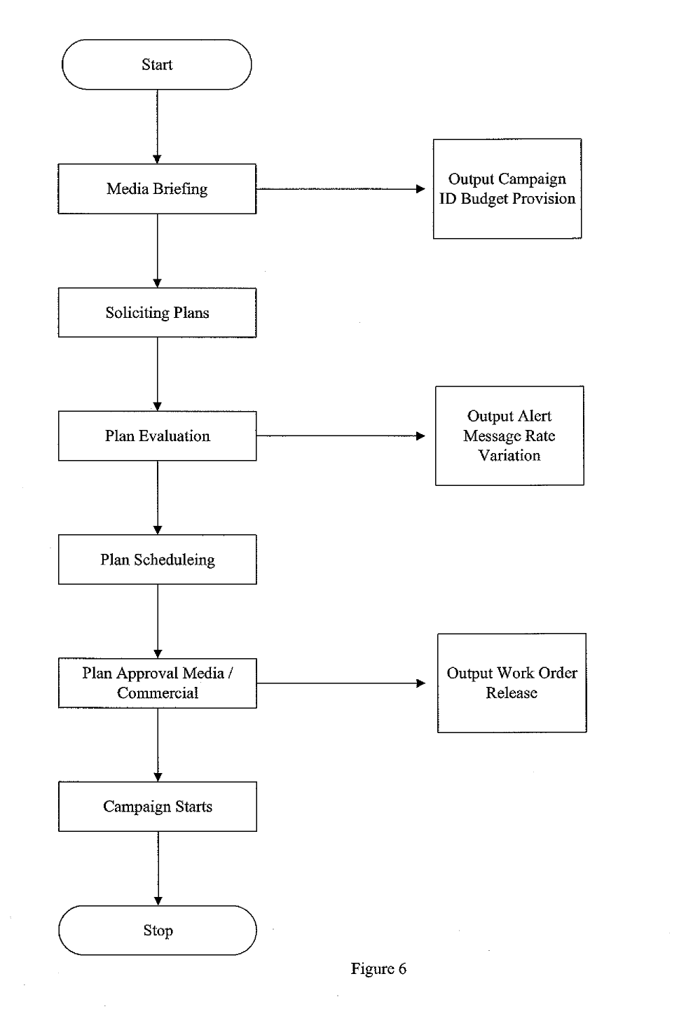

FIG. 6 explains the step of planning the campaign as per one embodiment of the present invention.

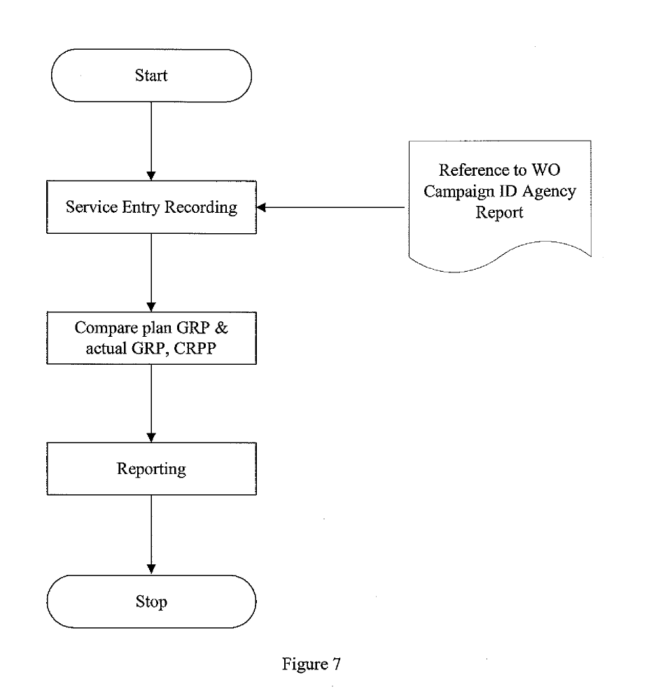

FIG. 7 explains the step of recording actual parameters of performance for evaluation as per one embodiment of the present invention.

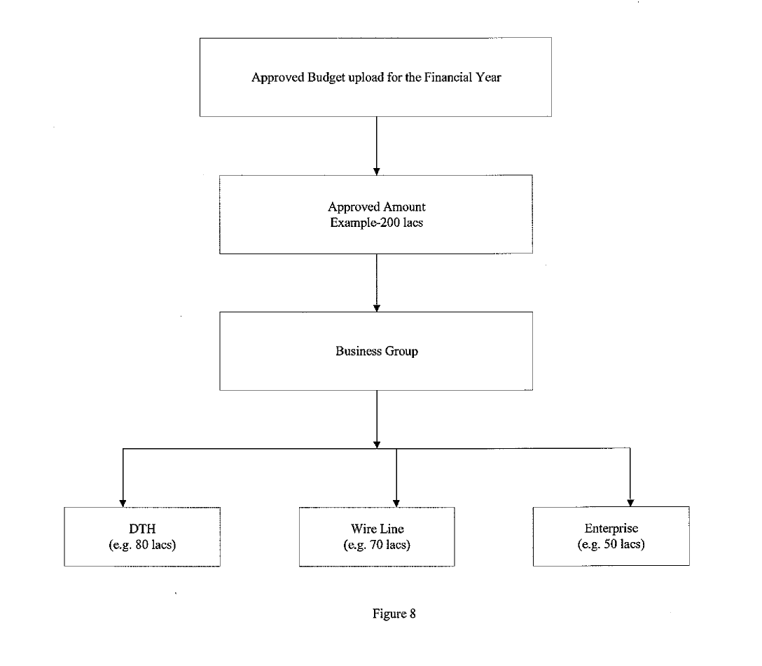

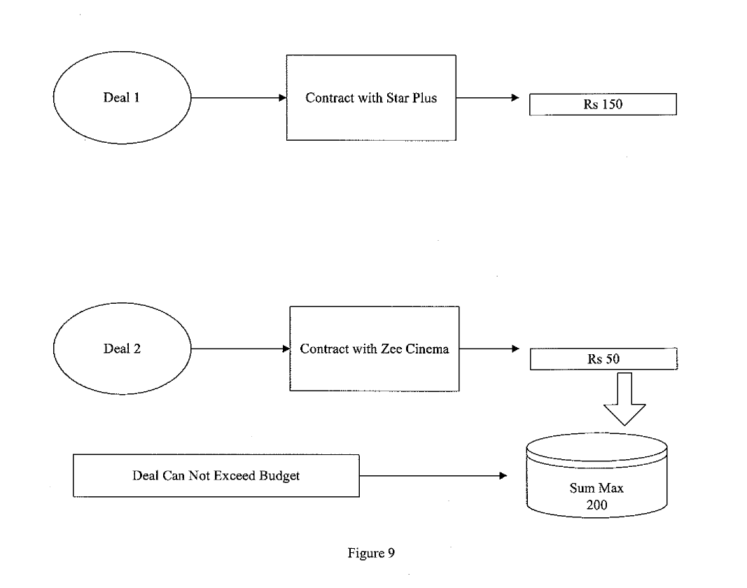

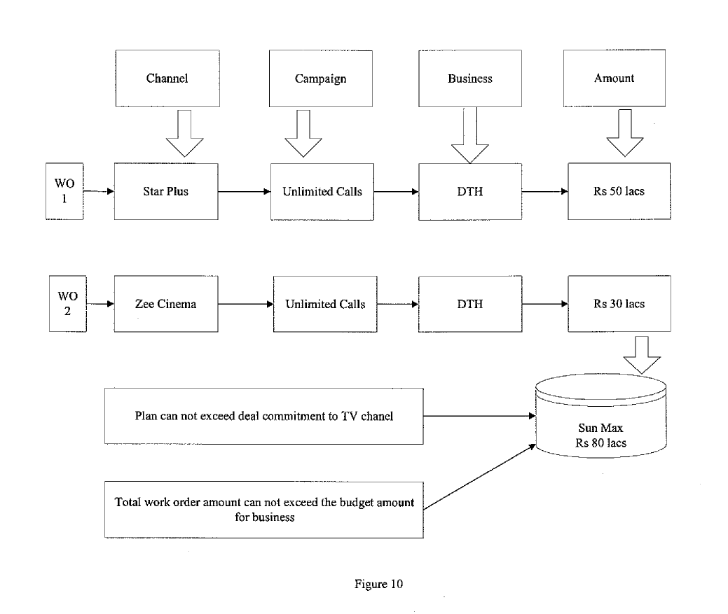

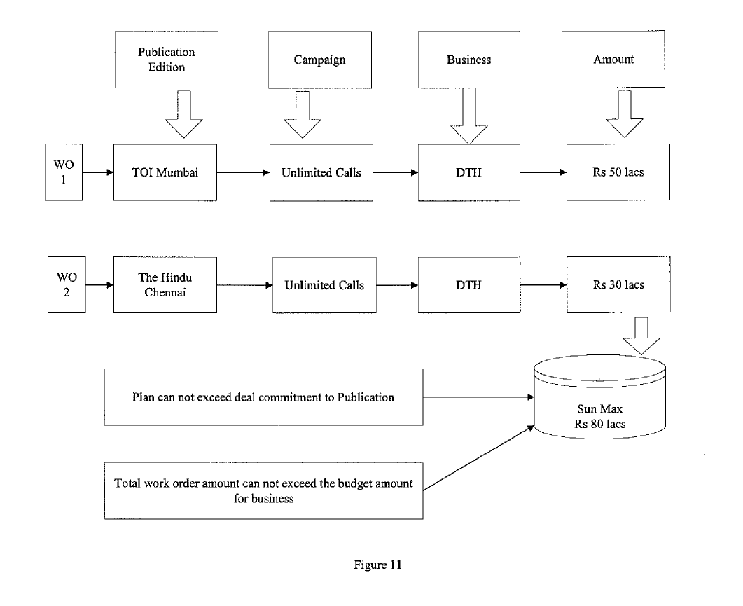

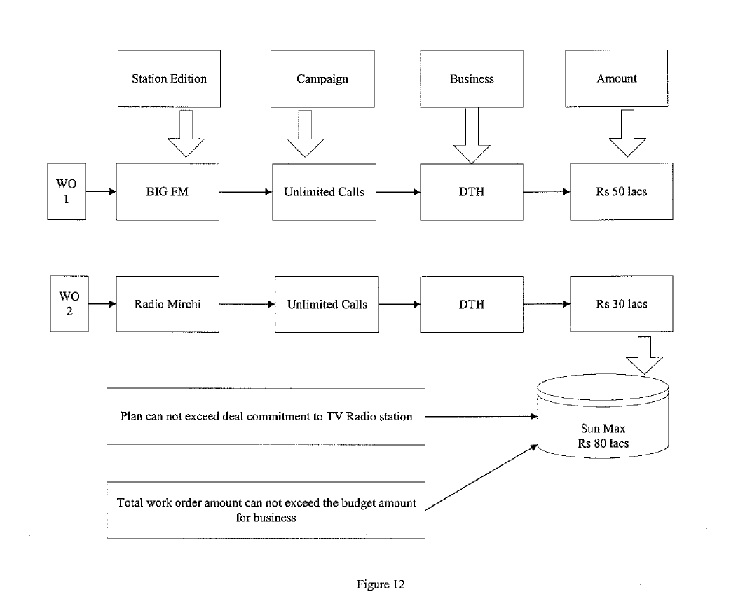

FIG. 8 to FIG. 12 explain validation procedures as per the embodiments of the present invention.

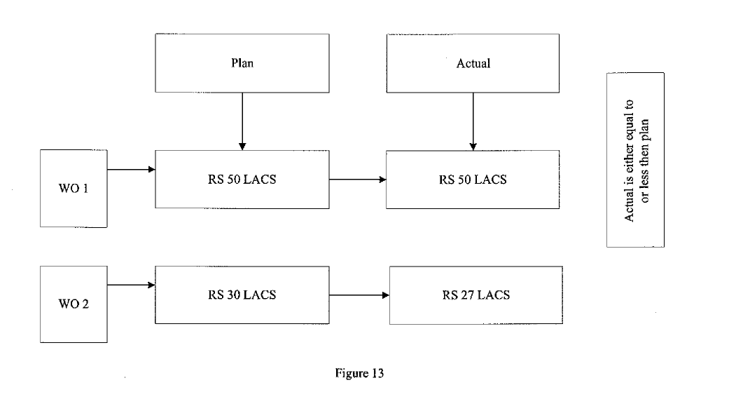

FIG. 13 explains checking procedure as per an embodiment of the present invention.

The description of FIGS. 6 to 13 is as explained below.

The step of budgeting involves steps of feeding into the system the budget for different media types such as TV, radio, print etc. For example the user may enter budget amount for each media type reference to account code, fund centers, and the media type. The system checks the value of each budget for further processing. The method involves calculating and recording the total budget amount, utilized amount and available amount for further utilization during the entire process of campaign management as explained.

Based on such information the value of the budget for usage may be released. The method of releasing includes checking by the system as to whether the user is an authorized user. Further, system also checks on date of such release. These features together form the “release procedure” that is inbuilt in the system. The actual usage then is carried out based on above information.

On basic processing of various information explained above a checking as to whether the deal contract value is exceeding the budget value is performed. If found so such alert is raised because a deal contract value cannot exceed the budget value. Furthermore, alert is also provided to the user if the plan transactions value exceeds the deal value.

The broad step of making a deal with respective mediums comprises steps of accepting input of channel name, which may generally be present in the system in master data module. Further information on program name, FCT rate, GRP are to be entered by the user. Such information on a long run would be fed from the master data module itself as the output of the analysis carried out in the current campaign management and analysis process acts as an input for future references.

Further the method also has mechanisms to avoid MIS-feeding of data. A few checks followed by the method are explained below:

System will validate data accuracy first and accept next.

When master information is being called at deal transaction by user wrong selection of input will be stopped by the system unless all the required data fields are entered by the user the transactions will not be processed by the system rather it shall be alerted through error.

Once the deal data is being processed by the systems it generates and allots unique deal number.

System will not process a deal transaction in case the deal value exceeds the budget amount.

GRP and CRPP will be collated by the system based on the formula inbuilt in the system, which will be analyzed for Management Information system Reporting as explained later in this document.

During the method of making of deal the channel module facilitates previous information (i.e. past record of performance parameters for such channel, as may be present in master data module). This information is displayed to the user in a prescribed format in order to direct the current deal in more favorable direction.

Further the broad step of planning of campaign in various medium comprises the steps of acquiring from master data module the information about channel name, or in case same is not present acquiring it from user. Further deal transaction details program name, time type, rate etc may also be acquired from the output of the deal making process explained above.

The method comprises further validating the said data's accuracy and then accepting such entries into the system database. Further the method ensures following checks to direct the method in desired direction.

System will validate data accuracy first and accept next. Further, when master info is being called at Plan transaction by user wrong selection of input will be stopped by the system then and there unless all the required data fields are entered by the user the transactions will not be processed by the system rather it through error. Once the plan data is being processed by the systems it generates and allots unique plan number.

System will not process a plan transaction in case the value exceeds the budget amount GRP and CRPP will be calculated by the system based on the formula inbuilt in the system, which will be analyzed for MIS Reporting.

All the plan value cannot exceed the budget amount and deal amount for which system logic is built, so user will be alerted for the wrong inputs.

As an outcome of the step of planning of campaign in a manner described above the plan would be recorded in the system. Further the execution of the campaigning would be with reference to the plan data.

The further step would be recording of actual data. This broad step would further involve the steps of collecting the actual data relating to the campaign program. The actual data may refer to various statistical collections of GRP of a channel or other popularity measurements of a medium.

The actual entry of the parameters measuring the viewer ship related information of a campaign would be recorded in the system with reference to the planning recorded earlier in the process. Plan data would also be analyzed with actual data to generate a variance report.

The variance calculations performed in the above step would be used for preparing the report. The reporting forms the part of management information system (MIS). Various reports may be formed which may later be referred manually as well as by the system for further calculations and analysis. Various reports that may be formed in this process are as follows:
Deal Evaluation Report—Contains channel and year wise channel revenue vs. advertiser spends a trend analysis.
Deal Track Report—Shows channel and program wise commercial time and value bought by the advertiser from the channels and utilizations for the specific period.
Deal Track Property Promo—Shows program wise property promo entitlements received by the advertiser from TV Media, Radio Media, and Internet Media and Outdoor media.
Plan entry report—Shows campaign, channel and program the plan schedule of the advertisements to be launched by the advertiser.
Actual entry—Shows campaign, channel and program the plan schedule of the advertisements to be launched correct it as actually launched by the advertiser.
Channel Reach and GRP Build Up—Shows channel and market wise GRP reach to understand the popularity of channel reference to markets generally cities.
Plan vs. Actual Summary weekly basis—Shows channel wise commercial duration versus actual consumption in terms of commercial time and value on weekly basis.

The present system and method about management and analysis of campaigning achieves an integrated system engulfing the entire process starting with dealing to the actual execution. The integration achieves many benefits such as actual performance analysis, which helps in further deal making process.

This therefore helps in aligning various processes related to campaigning for a large company wanting to campaign using various mediums. System automation achieved helps in using the already acquired information at the right place in the method of analysis. The overflow of information is managed as the same is put to realistic use. Overall manual intervention is reduced to a minimum amount as the same is taken care by maintaining data in databases.

The foregoing description of the invention has been described for purposes of clarity and understanding. It is not intended to limit the invention to the precise form disclosed.

We claim:

1. A method for facilitating media investment and inventory management, the method comprising the steps of:
initializing a deal of transaction with a required media campaign;
reviewing the deal;
presenting the reviewed deal for approval;
signing the deal on receipt of approval, else, renegotiating the deal and repeating the step of initializing the deal;
outputting the signed deal to the media; and
terminating the deal.

2. The method as in claim 1, wherein the media includes television channels, radio channels and publication houses.

3. The method as in claim 1, wherein the step of initializing the deal comprises the steps of:
accepting inputs including but not limited to channel name, program name, and FCT rate from a master data module;
accepting inputs of budget amount for media campaign from a user; and
calculating and recording the total budget amount, utilized amount and available amount for further utilization in the process of media campaign.

4. The method as in claim 1, wherein reviewing the deal comprises the steps of: checking if the user is an authorized user; checking the date of release of the reviewed deal; checking if the deal contract value is exceeding the total budget valued.

5. The method as in claim 4, wherein if the deal contract value is exceeds the total budget valued, an alert message is outputted to the user.

6. The method as in claim 1, wherein accuracy of each data is validated before accepting the next data.

7. The method as in claim 1, wherein a wrong selection of input by the user stops the deal of transaction with an error message and the deal is restarted only if all the required data are reentered by the user.

8. The method as in claim 1, wherein each deal of transaction is allotted a unique deal number.

9. The method as in claim 1, wherein terminating the deal terminates existing deal contract with the media and all subsequent processes of a deal transaction is terminated.

10. The method as in claim 1, wherein after termination of an existing deal with the media, a new deal can be entered with the same media for the same period.

11. A media investment and inventory management system comprising:
a plurality of modules that maintain master data and transaction data for:
initializing a deal of transaction with a required media campaign;
reviewing the deal;
presenting the reviewed deal for approval;
signing the deal on receipt of approval, else, renegotiating the deal and repeating the step of initializing the deal;
outputting the signed deal to the media; and
terminating the deal.

12. The system as in claim 11, wherein the master data is entered once and used for several times during the deal of transactions so that user time is saved and data security and accuracy are maintained.

13. The system as in claim 11, wherein the plurality of modules are but not limited to a master data module, a channel master module, a language module, a campaign master information module, a radio station master module, an edition master module, a city and market mapping master.

14. The system as in claim 11, wherein the media includes television channels, radio channels and publication houses.

15. The system as in claim 11, wherein accuracy of each data is checked and the data are stored in their respective database wherefrom the data can be recalled whenever required during the transaction.

16. The system as in claim 11, wherein the data are validated before getting accepted for the deal of transaction.

17. The system as in claim 11, wherein an unauthorized user is not allowed to edit the master data.

18. The system as in claim 11, wherein various reports are formed which can be referred manually as well as by the system for further calculations and analysis.
